(19) United States
(12) Patent Application Publication
(10) Pub. No.: US 2015/0213710 A1
(43) Pub. Date: Jul. 30, 2015

(54) Wireless To IR Remote Control Device

(71) Applicants: Jim Kinne, Alexandria, KY (US); Jan Larsen, Hudson, WI (US); Larry Jacoby, Downing, WI (US); Jeff Haagenstad, Eagan, MN (US)

(72) Inventors: Jim Kinne, Alexandria, KY (US); Jan Larsen, Hudson, WI (US); Larry Jacoby, Downing, WI (US); Jeff Haagenstad, Eagan, MN (US)

(21) Appl. No.: 14/164,813

(22) Filed: Jan. 27, 2014

(51) Int. Cl. G08C 17/02; G08C 23/04

(52) U.S. Cl. CPC G08C 17/02; G08C 23/04; G08C 2201/92

(57) ABSTRACT

An apparatus and a method are provided for a wireless Infrared (IR) converter to operate a legacy device by translating wireless commands into IR codes for transmission to an IR receiver within the legacy device. The wireless IR converter comprises a wireless control chip which receives commands from external wireless devices, and an IR output configured to convey IR codes to the IR receiver of the legacy device. Upon receiving commands from the wireless control chip, a microcontroller within the apparatus accesses a macro command library and an IR command library stored on a non-transitory machine-readable medium within the wireless IR converter. The macro command library and the IR command library enable the microcontroller to select IR codes corresponding to the received wireless commands. Once proper IR codes are selected, the IR output transmits the IR codes to the legacy device.

### FIELD

The field of the present invention generally relates to wireless computer connectivity. More particularly, the field of the invention relates to an apparatus and a method for connecting IR-enabled legacy devices wirelessly to existing computer networks and translating the IR codes associated with the devices to enable network communication therewith.

### BACKGROUND

A legacy system, or device, is generally defined as any method, technology, computer system, or application program which is outdated by current standards. Although the term “legacy” frequently is used in reference to outdated computer systems, the term often is used to describe any corporate computer system that is not Internet-dependent. There is a wide variety of reasons why organizations might continue using legacy devices. For example, the cost of replacing a particular legacy device with an updated device may be prohibitive. In other instances, the legacy device may be required to be continually available for service, thereby reducing an organization's motivation to take the device offline. Moreover, the cost of designing and installing updated devices which provide a similar degree of availability may be a deterrent. Thus, many organizations have compelling reasons to keep legacy devices in service.

With the advent of the Internet and network computing, there is a growing demand to enable legacy devices to send and receive information by way of the Internet. Although many legacy devices may be equipped with serial ports and Ethernet ports for connecting to the Internet, there is also a wide variety of devices that lack such connectivity. One alternative to physically networking legacy devices is to use wireless network connections. Many legacy devices, however, lack wireless network connectivity and are thus limited to Infrared (IR) communications by way of a handheld remote control. Older audio/video recorders and televisions are typical examples of IR-enabled legacy devices. While IR-enabled devices are operable from a distance (i.e., remotely without wires), they are limited to line-of-sight operations. Moreover, many legacy devices utilize IR codes that are incompatible with network communications protocols, and thus are not amenable to being wirelessly connected to the Internet. What is needed, therefore, is a method and an apparatus for connecting IR-enabled legacy devices wirelessly to existing computer networks and translating the IR codes associated with the devices to enable network communication with the devices.

### SUMMARY

An apparatus and a method are provided for a wireless Infrared (IR) converter to operate a legacy device by translating received wireless commands into IR codes for transmission to an IR receiver of the legacy device. Within the wireless IR converter is a wireless control chip which is configured to establish a wireless connection with an external wireless-enabled device. An IR output is configured to convey IR codes to the IR receiver of the legacy device. A macro command library and an IR command library are stored on a non-transitory machine-readable storage medium. The macro command library stores a set of pre-loaded command sequences, and the IR command library stores a set of IR codes that are associated with the legacy device. Upon receiving a command from the wireless control chip, a microcontroller within the apparatus accesses the macro command library and the IR command library to select a corresponding IR code or a series of IR codes (macros). Once the proper IR codes are selected, the IR output transmits the IR codes to the legacy device.

In an exemplary embodiment, an apparatus for operating a legacy device by translating received wireless commands into Infrared (IR) codes for transmission to an IR receiver of the legacy device comprises a wireless control chip configured to establish a wireless connection with an external wireless-enabled device; an IR output configured to convey IR codes to the IR receiver of the legacy device; a non-transitory machine-readable storage medium which stores at least a macro command library and an IR command library, wherein the macro command library stores a set of pre-loaded command sequences, and wherein the IR command library stores a set of IR codes that are associated with the legacy device; and a microcontroller, wherein upon receiving a command from the control chip, the microcontroller accesses the macro command library and the IR command library to select a corresponding IR code and then transmits the IR code to the legacy device by way of the IR output.

In another exemplary embodiment, the control chip is a wireless network interface controller (WiFi) which is compliant with Institute of Electrical and Electronics Engineers' (IEEE) 802.11 a/b/g/n standard, as well as any future modifications to the 802.11 wireless standard. In another exemplary embodiment, the control chip supports Bluetooth protocols. In another exemplary embodiment, the control chip supports Bluetooth SMART.

In another exemplary embodiment, the IR output is an Infrared Light Emitting Diode (IR LED). In another exemplary embodiment, each command sequence comprises at least one individual command. In another exemplary embodiment, the IR codes are installed into the IR command library by way of a training software application or by way of a temporary learning mode whereby an IR remote control associated with the legacy device transmits the IR codes to the apparatus.

In another exemplary embodiment, the control chip is further configured to transmit wireless commands to the external wireless-enabled device. In another exemplary embodiment, the apparatus is uniquely addressable on a local area network (LAN), thereby enabling interaction with the legacy device on the network. In another exemplary embodiment, two or more of said apparatus are grouped such that two or more legacy devices are controllable on a network.

In another exemplary embodiment, the apparatus is controlled by a user application configured to establish a suitable wireless connection. In another exemplary embodiment, the user application is a home automation system. In another exemplary embodiment, the user application is a dedicated tablet application. In another exemplary embodiment, the user application is a mobile browser application. In an exemplary embodiment, the user application is a desktop browser. In an exemplary embodiment, the user application is a Smart TV enabled browser.

In another exemplary embodiment, the apparatus is adhered to the exterior of the legacy device by way of an adhesive chemical layer, wherein the IR output is positioned directly over the IR receiver of the legacy device so as to transmit the IR codes directly to the IR receiver, and wherein wireless signals transmitted to and from the control chip are directed away from the legacy device. In another exemplary embodiment, the apparatus is adhered to the legacy device by way of Velcro. In another exemplary embodiment, the apparatus is adhered to the legacy device by way of mechanical fasteners. In another exemplary embodiment, the apparatus further comprises an IR receiver configured to receive IR signals from an IR remote control associated with the legacy device, wherein the received IR signals are electronically passed to the IR output and then transmitted to the IR receiver within the legacy device. In another exemplary embodiment, the apparatus further comprises a mechanical envelope having an unobstructed tunnel extending through the apparatus such that the IR receiver is accessible from outside the apparatus, thereby preserving functionality of an IR remote control associated with the legacy device. In another exemplary embodiment, the tunnel is made of a transparent material which allows IR codes transmitted by the remote control to pass through the apparatus and be received by the IR receiver. In another exemplary embodiment, the tunnel is an open passageway through the wireless IR converter. In another exemplary embodiment, the IR output is positioned adjacent to the tunnel such that IR codes transmitted by the IR output are directed toward the IR receiver.

In another exemplary embodiment, the apparatus further comprises one or more hardware ports so as to communicate with external devices by way of wires or cables. In another exemplary embodiment, the one or more hardware ports are serial communications channels. In another exemplary embodiment, the one or more hardware ports are RS-232 ports. In another exemplary embodiment, the one or more hardware ports comprise at least one relay input configured to detect a closing or an opening of an external relay. In another exemplary embodiment, the one or more hardware ports comprise at least one relay output configured to operate an external device requiring a switched input. In another exemplary embodiment, the one or more hardware ports comprise at least one 12V input configured to detect a 12V DC signal produced by an external device. In another exemplary embodiment, the one or more hardware ports comprise at least one 12V output configured to generate a 12V DC signal so as to operate an external device.

In an exemplary embodiment, a method of translating wireless commands into Infrared (IR) codes for transmission to an IR receiver of a legacy device comprises establishing a wireless connection between an external wireless-enabled device and a wireless control chip, whereby the wireless control chip receives wireless commands from the external wireless-enabled device; conveying a received command electronically from the control chip to a microcontroller; accessing a macro command library and an IR command library stored on a non-transitory machine-readable storage medium, wherein the macro command library comprises a set of pre-loaded command sequences, and wherein the IR command library comprises a set of IR codes that are associated with the legacy device selecting an IR code which corresponds to the command received from the control chip; and transmitting the IR code to the IR receiver of the legacy device by way of an IR output.

In an exemplary embodiment, a method of translating wireless commands into Infrared (IR) codes for transmission to an IR receiver of a legacy device comprises establishing a wireless connection between an external wireless-enabled device and a wireless control chip, whereby the wireless control chip receives wireless commands from the external wireless-enabled device and then conveys the commands electronically to a microcontroller; receiving a command from the control chip to the microcontroller; accessing a macro command library and an IR command library stored on a non-transitory machine-readable storage medium, wherein the macro command library stores a set of pre-loaded command sequences, and wherein the IR command library stores a set of IR codes that are associated with the legacy device selecting an IR code which corresponds to the command received from the control chip; and transmitting the IR code to the IR receiver of the legacy device by way of an IR output.

In an exemplary embodiment, a method of translating wireless commands into Infrared (IR) codes for transmission to an IR receiver of a legacy device comprises providing a wireless IR converter comprising a Printed Circuit Board (PCB), wherein a first side of the PCB includes at least a battery retained within a battery holder and a wireless transmitter-receiver control chip, and a second side of the PCB includes at least a microcontroller, a non-transitory machine-readable medium, and an IR output, and wherein the PCB is housed within a mechanical envelope; adhering the wireless IR converter to the exterior of the legacy device by way of an adhesive chemical layer, such that the IR output is positioned directly over the IR receiver; transmitting at least one command to the wireless transmitter-receiver control chip by way of an external wireless-enabled device; passing the at least one command electronically from the wireless transmitter-receiver control chip to the microcontroller; causing the microcontroller to access a macro command library and a IR command library stored on the non-transitory machine readable medium so as to select one or more IR codes corresponding to the at least one command; and transmitting the one or more IR codes to the IR receiver by way of the IR output.

In an exemplary embodiment, providing the wireless IR converter further comprises further configuring an IR receiver within the wireless IR converter to receive IR signals from the IR remote control, wherein the received IR signals are electronically passed to the IR output and then transmitted to the IR receiver within the legacy device. In an exemplary embodiment, providing the wireless IR converter further comprises extending an unobstructed tunnel through the mechanical envelope such that the IR receiver is accessible from outside the wireless IR converter, thereby preserving functionality of an IR remote control associated with the legacy device. In an exemplary embodiment, extending the unobstructed tunnel through the mechanical envelope further comprises forming the tunnel of a transparent material which allows the IR codes transmitted by the remote control to pass through the apparatus and be received by the IR receiver. In an exemplary embodiment, providing the wireless IR converter further comprises positioning the IR output adjacent to the tunnel such that the IR codes transmitted by the IR output are directed toward the IR receiver.

### BRIEF DESCRIPTION OF THE DRAWINGS

The drawings refer to embodiments of the present invention in which:

FIG. 1 illustrates an exemplary use environment wherein an embodiment of a legacy device is shown before and after installation of a wireless IR converter in accordance with the present invention;

FIG. 2A is a top view of an exemplary embodiment of a Printed Circuit Board comprising a wireless IR converter according to the present invention;

FIG. 2B is a bottom view of an exemplary embodiment of a Printed Circuit Board comprising a wireless IR converter according to the present invention;

FIG. 2C is a side view of an exemplary embodiment of a wireless IR converter installed onto the front surface of a legacy device in accordance with the present invention;

FIG. 3 illustrates an exemplary use environment wherein an embodiment of a wireless IR converter is installed onto the front surface of a legacy device in accordance with the present invention;

FIG. 4 is a schematic of an exemplary embodiment of a wireless IR converter, according to the present invention;

FIG. 5 is a schematic of an exemplary embodiment of a wireless IR converter, according to the present invention; and

FIG. 6 is a schematic of an exemplary embodiment of a wireless IR converter in accordance with the present invention.

While the present invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present invention.

### DETAILED DISCUSSION

In the following description, numerous specific details are set forth in order to provide a thorough understanding of the present invention. It will be apparent, however, to one of ordinary skill in the art that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

In general, the present invention describes an apparatus and a method for a wireless Infrared (IR) converter to operate a legacy device by translating received wireless commands into IR codes for transmission to an IR receiver within the legacy device. The wireless IR converter preferably is affixed to the exterior of the legacy device such that an IR output is positioned directly over the IR receiver. The IR output transmits the IR codes directly to the IR receiver while wireless signals are directed away from the legacy device. The IR output preferably is an Infrared Light Emitting Diode (IR LED), although other suitable sources of Infrared radiation will be apparent to those skilled in the art. In some embodiments, the wireless IR converter may include a mechanical envelope having an unobstructed tunnel extending there through such that the IR receiver remains accessible to an IR remote control associated with the legacy device. Within the wireless IR converter is a wireless control chip configured to establish a wireless connection with external wireless devices. The control chip may be a wireless network interface controller (WiFi), or may be configured to support Bluetooth protocols, such as Bluetooth SMART. In some embodiments, the wireless IR converter may be uniquely addressable on a local area network (LAN), thereby enabling interaction with the legacy device on the network. In other embodiments, two or more wireless IR converters may be grouped such that two or more legacy devices may be controlled on the network. In some embodiments, the control chip may be configured to transmit wireless commands to external wireless devices, in addition to receiving commands. A macro command library and an IR command library are stored on a non-transitory machine-readable storage medium. The macro command library stores a set of pre-loaded command sequences, and the IR command library stores a set of IR codes that are associated with the legacy device. Upon receiving a command from the wireless control chip, a microcontroller within the wireless IR converter accesses the macro command library and the IR command library to select a corresponding IR code. Once the proper IR code is selected, the IR output then transmits the IR code to the IR receiver within the legacy device.

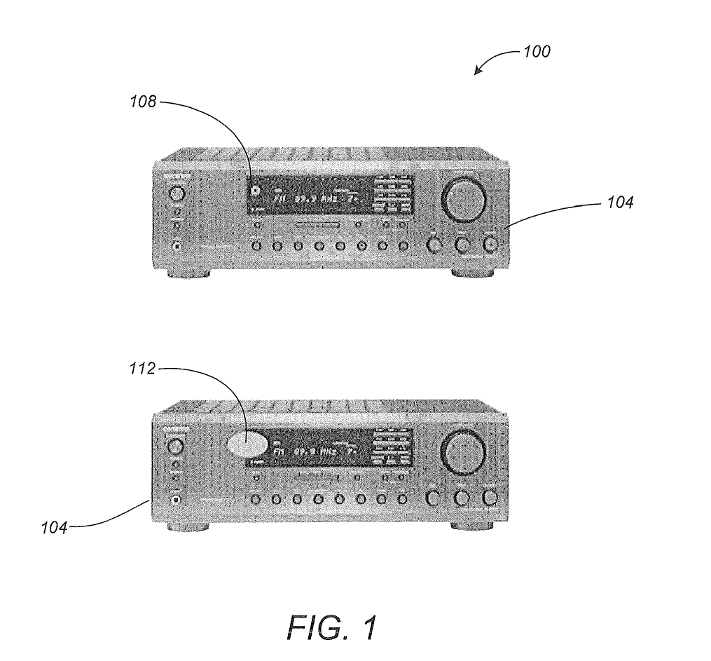

FIG. 1 illustrates an exemplary use environment 100 wherein an embodiment of a legacy device 104 is shown before and after installation of a wireless IR converter 112 in accordance with the present invention. The legacy device 104 comprises an IR receiver 108, upon which the wireless IR converter 112 is adhered by way of an adhesive chemical layer or other similar means. In another embodiment, the wireless IR converter 112 may be adhered by way of Velcro. In another embodiment, the wireless IR converter 112 may be adhered by way of fasteners, such as screws or other similar hardware. During operation, the wireless IR converter 112 receives user-initiated commands by way of a wireless data link, such as WiFi, Bluetooth, Bluetooth Low Energy (“Bluetooth SMART”), or other similar public or proprietary wireless communications means. The wireless IR converter 112 translates the received commands into corresponding IR codes and then transmits the IR codes to the IR receiver 108, thereby enabling remote operation of the legacy device 104. Although the legacy device 104 illustrated in FIG. 1 has the appearance of a typical audio/video component, it is envisioned that the wireless IR converter 112 may be utilized in conjunction with any form of legacy device that receives commands by way of IR codes.

It will be appreciated that each model and type of the legacy device 104 will have specific IR codes that are not necessarily the same those certain IR codes applicable to other models and types of the legacy device 104. Thus, in order for the wireless IR converter 112 to effectively operate a particular legacy device, the wireless IR converter 112 must have those certain IR codes specific to the particular legacy device stored in memory. In one embodiment, the IR codes associated with the legacy device 104 may be loaded into a non-transitory machine-readable storage medium, or a memory, of the wireless IR converter 112 by way a manufacturer supplied “training” software application. It is envisioned that upon first using the wireless IR converter 112, the user may run the software application on a personal computer (PC), whereby the user may specify a particular make and model of the legacy device 104. Those certain IR codes associated with the selected make and model of the legacy device 104 may then be copied from the PC to the memory of the wireless IR converter 112 by way of a data connection such as, by way of example, a Universal Serial Bus (USB) connection. In another embodiment, the IR codes may be “learned” by way of the legacy device's IR remote control. It is envisioned that the wireless IR converter 112 may be placed into a temporary “learning mode” whereby the IR codes are received from the legacy device's IR remote control and then stored in the memory of the wireless IR converter 112.

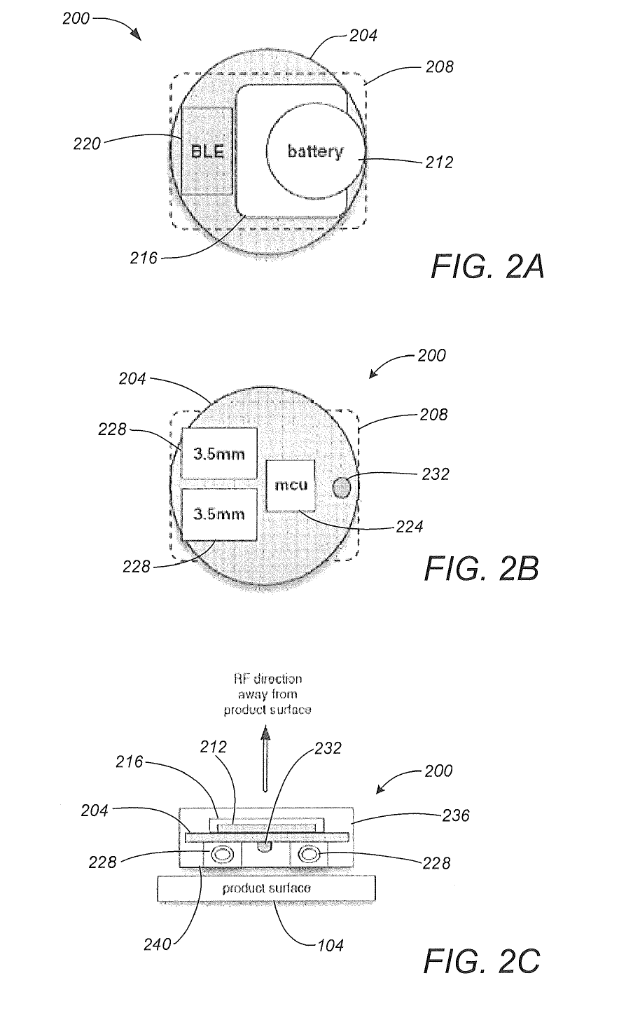

FIGS. 2A-2B illustrate several internal components comprising an exemplary embodiment of a wireless IR converter 200. In order to facilitate adhering the wireless IR converter 200 to the legacy device 104, or other similar device, the wireless IR converter 200 is advantageously designed to be small and thin. In the illustrated embodiment of FIGS. 2A-2B, the wireless IR converter 200 comprises a thin, generally circular Printed Circuit Board (PCB) 204. In another embodiment, a rectangular PCB 208 may be utilized. In still another embodiment, the PCB may be an oval. Those of ordinary skill in the art will recognize that a variety of shapes of the PCB may be utilized, depending on the specific applications envisioned for the wireless IR converter 200, without detracting from the scope of the present invention.

FIG. 2A illustrates a top view of the PCB 204 comprising the wireless IR converter 200. The top of the PCB 204 comprises a battery 212 retained within a battery holder 216, and a wireless transmitter-receiver control chip 220, in this instance labeled as a Bluetooth Low Energy (BLE) device. The control chip 220 enables wireless connections to be established between the wireless IR converter 200 and other wireless-enabled devices such as, but not necessarily limited to, a PC, a laptop computer, a tablet computer, a mobile computer, a mobile phone, and any other similar device capable of participating in wireless communications with the wireless IR converter 200. In one embodiment, the control chip 220 is a wireless network interface controller (WiFi), and thus is compliant with Institute of Electrical and Electronics Engineers' (IEEE) 802.11 a/b/g/n standard, as well as any future modifications to the 802.11 wireless standard. In another embodiment, the control chip 220 may be Bluetooth-enabled and thus supports wireless connections by way of Bluetooth protocols, Bluetooth Low Energy (BLE), and Bluetooth SMART. It will be appreciated that the control chip 220 may be designed to support a wide variety of public and proprietary wireless communications means without deviating from the scope of the present invention.

FIG. 2B illustrates a bottom view of the PCB 204 comprising the wireless IR converter 200. The bottom of the PCB 204 comprises a microcontroller 224, a pair of exemplary serial communications jacks 228, and an IR output 232. The IR output 232 preferably is an IR light emitting diode (IR LED), although other suitable sources of IR light will be apparent to those skilled in the art. As discussed below in greater detail, the microcontroller 224 essentially converts commands received by way of the control chip 220 into corresponding IR codes that are then transmitted to the legacy device 104 by way of the IR output 232. The exemplary serial communications jacks 228 facilitate interfacing the wireless IR converter 200 with other devices. In one embodiment, the serial communications jacks 228 may be configured to accept serial commands or data from an external device or to transmit serial commands or data to an external device. Other similar functions of the serial communications jacks 228 will be apparent to those skilled in the art.

FIG. 2C illustrates a side view of the wireless IR converter 200 installed within a mechanical envelope 236 which is adhered to the front surface of the legacy device 104. For the purpose of description, the mechanical envelope 236 illustrated in FIG. 2C is transparent so as to clearly show the positions of the components discussed with respect to FIGS. 2A-2B. The mechanical envelope 236 preferably has an adhesive chemical layer 240, or other similar means, to enable adhering the converter to the legacy device 104, such that the IR output 232 is facing toward the IR receiver (not shown) within the legacy device 104. As will be apparent to those skilled in the art, positioning the IR output 232 toward the legacy device 104 also directs wireless signals arriving to and from the control chip 220 away from the legacy device 104, thereby reducing a possibility of radio frequency (RF) interference affecting the legacy device 104. It will be further apparent to those skilled in the art that the mechanical envelope 236 may be adhered to the legacy device 104 by other than the adhesive chemical layer 240. For example, in another embodiment, the mechanical envelope 236 may be adhered to the legacy device 104 by way of Velcro. In another embodiment, the mechanical envelope 236 may be adhered to the legacy device 104 by way of fasteners, such as screws or other similar hardware.

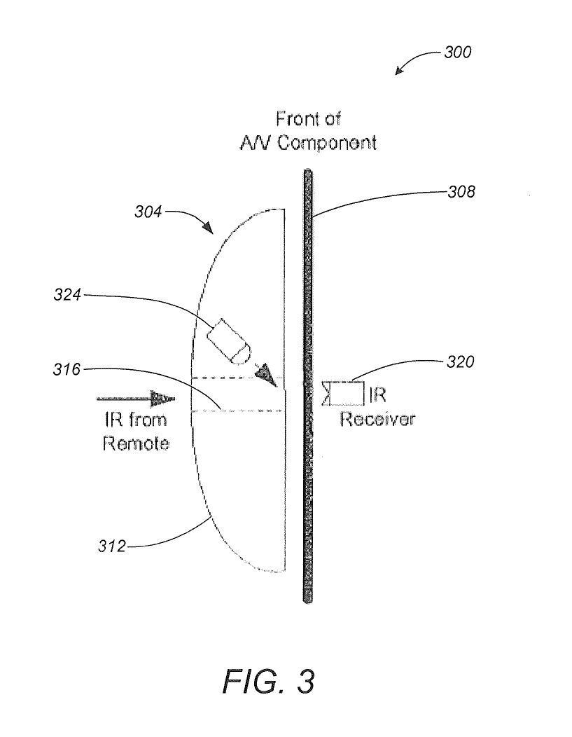

FIG. 3 illustrates an exemplary use environment 300 wherein an embodiment of a wireless IR converter 304 is affixed to the front surface of a legacy device 308 in accordance with the present invention. In the illustrated embodiment, the wireless IR converter 304 comprises a rounded mechanical envelope 312 which includes a tunnel 316 extending through the wireless IR converter 304. It will be appreciated that the tunnel 316 advantageously enables wireless operation of the legacy device 308 while also preserving the functionality of an IR remote control associated with the legacy device 308. The tunnel 316 preferably is made of a transparent material which allows IR codes transmitted by the remote control to pass through the wireless IR converter 304 and be received by an IR receiver 320 within the legacy device 308. In another embodiment, the tunnel 316 may be an open passageway through the wireless IR converter 304. The wireless IR converter 304 further comprises an IR output 324 which is positioned adjacent to the tunnel 316 such that IR codes transmitted by the IR output 324 are directed toward the IR receiver 320 within the legacy device 308. Those skilled in the art will appreciate that several other components that are substantially similar to those certain components discussed above in connection with FIGS. 2A-2C, though not shown in FIG. 3, will be positioned within the wireless IR converter 304 such that the tunnel 316 is unobstructed. In still another embodiment, the tunnel 316 may be omitted in lieu of an IR receiver on the exterior face of the wireless IR converter 304, whereby IR signals from the remote control are received and then passed electronically to the IR output 324 which then passes those signals to the IR receiver 320.

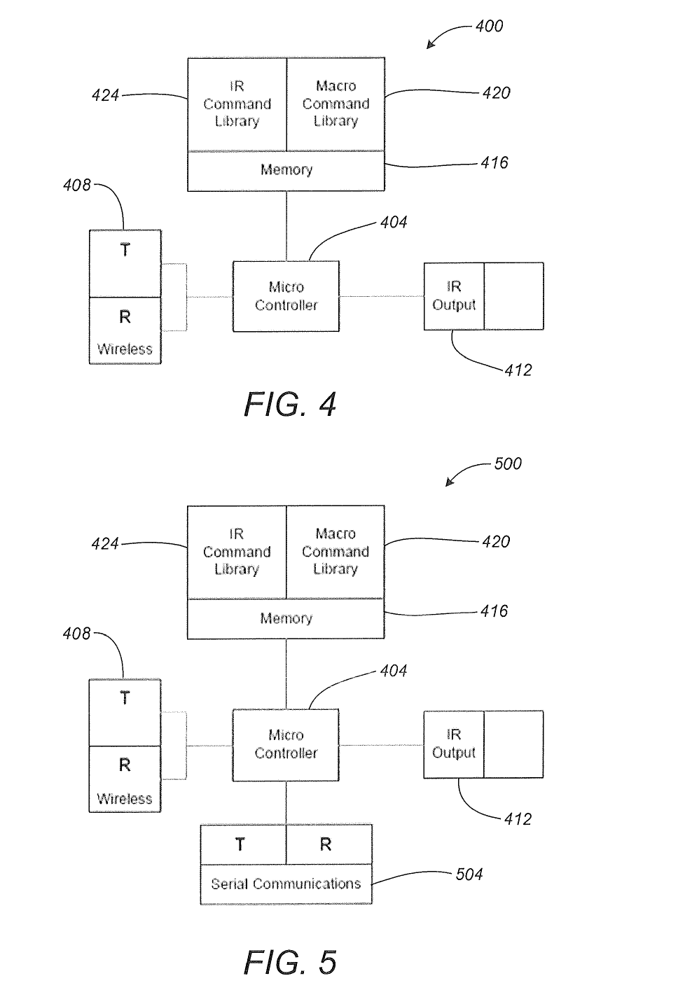

FIG. 4 is a schematic of an exemplary embodiment of a wireless IR converter 400, according to the present invention. The wireless IR converter 400 comprises a microcontroller 404, a wireless transmitter-receiver control chip 408, and an IR output 412. As discussed with reference to FIGS. 1-3, the control chip 408 enables wireless connections to be established between the wireless IR converter 400 and other wireless-enabled devices. The control chip 408 may be a wireless network interface controller (WiFi), or in other embodiments the control chip 408 may support Bluetooth protocols, Bluetooth Low Energy (BLE), and Bluetooth SMART, as well as any other similar public or proprietary wireless communications protocols. The IR output 412 preferably is of the IR LED variety, although other sources of IR light suitable for conveying IR codes to the legacy device 104 (308) will be apparent to those skilled in the art.

The wireless IR converter 400 further comprises a non-transitory machine-readable. storage medium (i.e., “a memory”) 416, which stores a macro command library 420 and an IR command library 424. The macro command library 420 stores a set of pre-loaded command sequences, each of which comprising one or more individual commands. The IR command library 424 stores a set of IR codes that are associated with the particular legacy device 104 (308) to be wirelessly controlled. As discussed with reference to FIG. 1, the IR codes may be user-installed by way of a training software application, or may be loaded into the IR command library 424 by way of an IR remote control associated with the legacy device 104 (308) during a temporary learning mode of the wireless IR converter 400.

The macro command library 420 and the IR command library 424 provide the microcontroller 404 with a mapping, or a translation, between wireless commands received by way of the control chip 408 and the IR codes that must be transmitted by way of the IR output 412 so as to control the legacy device 104 (308). During operation of the wireless IR converter 400, upon receiving a command by way of the control chip 408, the microcontroller 404 accesses the macro command library 420 and the IR command library 424 in an attempt to find a particular IR code which corresponds with the received wireless command. Once the appropriate IR code is selected in the IR command library 424, the microcontroller 404 transmits the IR code to the legacy device 104 (308) by way of the IR output 412.

It will be appreciated that the memory 416 need not be limited to storing the macro command library 420 and the IR command library 424, but rather a wide variety of functions and resources may be stored on the memory 416. In the embodiments discussed in connection with FIGS. 1-3, the wireless IR converter receives wireless commands from external wireless-enabled devices. In other embodiments, however, the wireless IR converter may also transmit wireless commands, as well as receive wireless commands, thereby enabling remote interaction between wireless-enabled devices and the legacy device 104 (308). Moreover, in some embodiments, the wireless IR converter 400 may be uniquely addressable on a local area network (LAN) so as to enable interacting with and controlling individual legacy devices on the network. In other embodiments, a multiplicity of wireless IR converters may be grouped so as to allow control of multiple legacy devices. It is envisioned that in other embodiments, the wireless IR converter 400 may be controlled via any user application that is capable of establishing a suitable wireless connection. For example, the wireless IR converter 400 may be controlled by a home automation system, a computer or web browser application, dedicated phone and tablet applications, mobile browser applications, a Smart TV enabled browser, and the like.

Those skilled in the art will appreciate that in addition to transmitting and receiving commands wirelessly, the wireless IR converter may also have hardware inputs and outputs so as to communicate by way of various wires and cables. FIG. 5 is a schematic of an exemplary embodiment of a wireless IR converter 500, which is substantially similar to the wireless IR converter 400, with the exception that the wireless IR converter 500 further comprises serial communications channels 504. The serial communications channels 504 may comprise, by way of example, but not necessarily limited to, RS-232 ports, RS-485 ports, a CAN-bus, or any other type of port or channel suitable for analog or digital communications. In one embodiment, the serial communications channels 504 may be individually configured to accept serial commands or data from an external device. In another embodiment, the serial communications channels 504 may be configured to transmit serial commands or data to the external device. In still another embodiment, the serial communications channels 504 may be configured to participate in analog or digital communications with the external device.

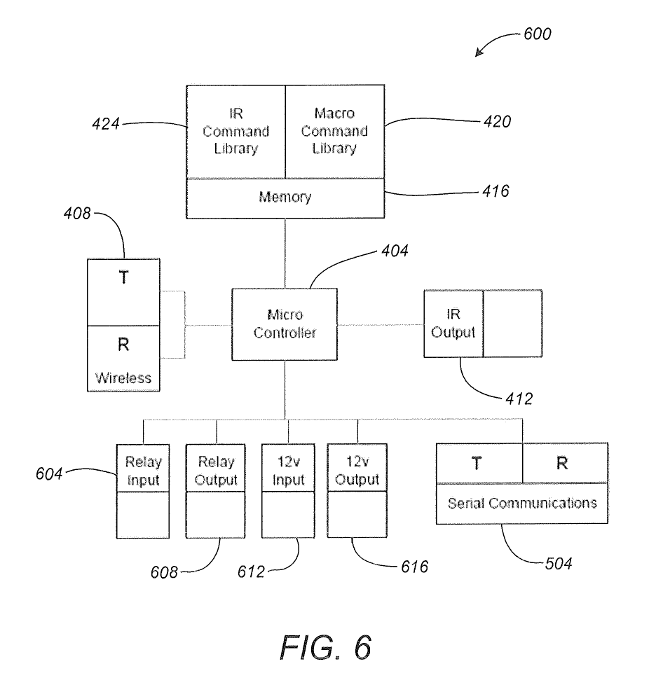

It will be further appreciated that the wireless IR converter 500 need not be limited to the serial communications channels 504, but rather other types of inputs and outputs may be utilized without deviating from the spirit and scope of the present invention. FIG. 6 is a schematic of an exemplary embodiment of a wireless IR converter 600, which is substantially similar to the wireless IR converters 400, 500, with the exception that the wireless IR converter 600 further comprises exemplary inputs and outputs including a relay input 604, a relay output 608, a 12V input 612, and a 12V output 616. Those skilled in the art will recognize that the relay input 604 may be used to detect a closing and/or an opening of an external relay or switch. Meanwhile, the relay output 608 may be used as an internal relay or switch so as to operate an external device such as, by way of example, a light, a fan, or any other similar device requiring a switched input. Similarly, the 12V input 612 may be utilized to detect a 12V DC signal produced by an external device, such as, for example, a temperature sensor which is external to the wireless IR converter 600. The 12V output 616 may be used to generate a 12V DC signal so as to operate an external device, such as, by way of example, signaling an external, controlled amplifier to turn on its power. It is envisioned that the wireless IR converter may be coupled with other types of inputs and outputs than illustrated and described herein, and will be apparent to those skilled in the art without deviating beyond the scope of the present invention.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The present invention is to be understood as not limited by the specific embodiments described herein, but only by scope of the appended claims.

1. An apparatus for operating a legacy device by translating received wireless commands into Infrared (IR) codes for transmission to an IR receiver of the legacy device, the apparatus comprising:
a wireless control chip configured to establish a wireless connection with an external wireless-enabled device;
an IR output configured to convey IR codes to the IR receiver of the legacy device;
a non-transitory machine-readable storage medium which stores at least a macro command library and an IR command library, wherein the macro command library stores a set of pre-loaded command sequences, and wherein the IR command library stores a set of IR codes that are associated with the legacy device; and
a microcontroller, wherein upon receiving a command from the control chip, the microcontroller accesses the macro command library and the IR command library to selects at least one corresponding IR code and then transmits the at least one IR code to the legacy device by way of the IR output.

2. The apparatus of claim 1, wherein the control chip is a wireless network interface controller (WiFi) which is compliant with Institute of Electrical and Electronics Engineers' (IEEE) 802.11 a/b/g/n standard.

3. The apparatus of claim 1, wherein the control chip supports Bluetooth protocols.

4. The apparatus of claim 3, wherein the control chip supports Bluetooth SMART protocols.

5. The apparatus of claim 1, wherein the IR output is a source of Infrared radiation.

6. The apparatus of claim 5, wherein the IR output is an Infrared Light Emitting Diode (IR LED).

7. The apparatus of claim 1, wherein each command sequence comprises at least one individual command.

8. The apparatus of claim 1, wherein the IR codes are installed into the IR command library by way of a training software application or by way of a temporary learning mode whereby an IR remote control associated with the legacy device transmits the IR codes to the apparatus.

9. The apparatus of claim 1, wherein the control chip is further configured to transmit wireless commands to the external wireless-enabled device.

10. The apparatus of claim 1, wherein the apparatus is uniquely addressable on a local area network (LAN), thereby enabling interaction with the legacy device on the network.

11. The apparatus of claim 10, wherein two or more of said apparatus are grouped such that two or more legacy devices are controllable on a network.

12. The apparatus of claim 1, wherein the apparatus is controlled by a user application configured to establish a suitable wireless connection.

13. The apparatus of claim 12, wherein the user application is a home automation system.

14. The apparatus of claim 12, wherein the user application is a dedicated tablet application.

15. The apparatus of claim 12, wherein the user application is a mobile browser application.

16. The apparatus of claim 12, wherein the user application is a desktop browser.

17. The apparatus of claim 12, wherein the user application is a Smart TV enabled browser.

18. The apparatus of claim 1, wherein the apparatus is adhered to the exterior of the legacy device, such that the IR output is positioned directly over the IR receiver of the legacy device so as to transmit the IR codes directly to the IR receiver, and wherein wireless signals transmitted to and from the control chip are directed away from the legacy device.

19. The apparatus of claim 18, wherein the apparatus is adhered to the legacy device by way of an adhesive chemical layer.

20. The apparatus of claim 18, wherein the apparatus is adhered to the legacy device by way of Velcro.

21. The apparatus of claim 18, wherein the apparatus is adhered to the legacy device by way of mechanical fasteners.

22. The apparatus of claim 1 further comprising an IR receiver configured to receive IR signals from an IR remote control associated with the legacy device, wherein the received IR signals are electronically passed to the IR output and then transmitted to the IR receiver within the legacy device.

23. The apparatus of claim 1, wherein the apparatus further comprises a mechanical envelope having an unobstructed tunnel extending through the apparatus such that the IR receiver is accessible from outside the apparatus, thereby preserving functionality of an IR remote control associated with the legacy device.

24. The apparatus of claim 23, wherein the tunnel is made of a transparent material which allows IR codes transmitted by the remote control to pass through the apparatus and be received by the IR receiver.

25. The apparatus of claim 23, wherein the tunnel is an open passageway through the wireless IR converter.

26. The apparatus of claim 23, wherein the IR output is positioned adjacent to the tunnel such that IR codes transmitted by the IR output are directed toward the IR receiver.

27. The apparatus of claim 1, wherein the apparatus further comprises one or more hardware ports so as to participate in analog or digital communications with external devices by way of wires or cables.

28. The apparatus of claim 27, wherein the one or more hardware ports are serial communications channels.

29. The apparatus of claim 28, wherein the one or more hardware ports are RS-232 ports.

30. The apparatus of claim 27, wherein the one or more hardware ports comprise at least one relay input configured to detect a closing or an opening of an external relay.

31. The apparatus of claim 27, wherein the one or more hardware ports comprise at least one relay output configured to operate an external device requiring a switched input.

32. The apparatus of claim 27, wherein the one or more hardware ports comprise at least one 12V input configured to detect a 12V DC signal produced by an external device.

33. The apparatus of claim 27, wherein the one or more hardware ports comprise at least one 12V output configured to generate a 12V DC signal so as to operate an external device.

34. A method of translating wireless commands into Infrared (IR) codes for transmission to an IR receiver of a legacy device, the method comprising:
establishing a wireless connection between an external wireless-enabled device and a wireless control chip, whereby the wireless control chip receives wireless commands from the external wireless-enabled device;
conveying a received command electronically from the control chip to a microcontroller;
accessing a macro command library and an IR command library stored on a non-transitory machine-readable storage medium, wherein the macro command library comprises a set of pre-loaded command sequences, and wherein the IR command library comprises a set of IR codes that are associated with the legacy device
selecting an IR code which corresponds to the command received from the control chip; and
transmitting the IR code to the IR receiver of the legacy device by way of an IR output.

35. A method of translating wireless commands into Infrared (IR) codes for transmission to an IR receiver of a legacy device, the method comprising:
providing a wireless IR converter comprising a Printed Circuit Board (PCB), wherein a first side of the PCB includes at least a battery retained within a battery holder and a wireless transmitter-receiver control chip, and a second side of the PCB includes at least a microcontroller, a non-transitory machine-readable medium, and an IR output, and wherein the wireless IR converter is housed within a mechanical envelope;
adhering the wireless IR converter to the exterior of the legacy device by way of an adhesive chemical layer, such that the IR output is positioned directly over the IR receiver;
transmitting at least one command to the wireless transmitter-receiver control chip by way of an external wireless-enabled device;
passing the at least one command electronically from the wireless transmitter-receiver control chip to the microcontroller;
causing the microcontroller to access a macro command library and a IR command library stored on the non-transitory machine readable medium so as to select one or more IR codes corresponding to the at least one command; and
transmitting the one or more IR codes to the IR receiver by way of the IR output.

36. The method of claim 35, wherein providing the wireless IR converter further comprises, further configuring an IR receiver within the wireless IR converter to receive IR signals from an IR remote control, wherein the received IR signals are electronically passed to the IR output and then transmitted to the IR receiver within the legacy device.

37. The method of claim 35, wherein providing the wireless IR converter further comprises extending an unobstructed tunnel through the mechanical envelope such that the IR receiver is accessible from outside the wireless IR converter, thereby preserving functionality of an IR remote control associated with the legacy device.

38. The method of claim 37, wherein extending the unobstructed tunnel through the mechanical envelope further comprises forming the tunnel of a transparent material which allows the IR codes transmitted by the remote control to pass through the apparatus and be received by the IR receiver.

39. The method of claim 37, wherein providing the wireless IR converter further comprises positioning the IR output adjacent to the tunnel such that the IR codes transmitted by the IR output are directed toward the IR receiver.
